(19) United States
(12) Patent Application Publication
(10) Pub. No.: US 2023/0183569 A1
(43) Pub. Date: Jun. 15, 2023

(54) HALIDE-BASED SCINTILLATOR MATERIALS

(71) Applicant: Radiation Monitoring Devices, Inc., Watertown, MA (US)

(72) Inventors: Edgar V. Van Loef, Watertown, MA (US); Jaroslaw Glodo, Allston, MA (US); Pijush Bhattacharya, Watertown, MA (US); Lakshmi Soundara Pandian, Arlington, MA (US); Kanai S. Shah, Watertown, MA (US)

(73) Assignee: Radiation Monitoring Devices, Inc., Watertown, MA (US)

(21) Appl. No.: 17/880,203

(22) Filed: Aug. 3, 2022

Related U.S. Application Data
(60) Provisional application No. 63/229,036, filed on Aug. 3, 2021.

(51) Int. Cl. C09K 11/77; G01T 1/20; C09K 11/62

(52) U.S. Cl. CPC C09K 11/7705; G01T 1/20; C09K 11/628

(57) ABSTRACT

Halide-based scintillator materials, and related systems and methods are generally described. In some embodiments, the scintillator materials are thallium-based and/or have a perovskite structure. Specific embodiments of thallium calcium halides and thallium magnesium halides with desirable scintillation properties are provided.

### RELATED APPLICATIONS

This application claims priority to U.S. Provisional Application No. 63/229,036, filed Aug. 3, 2021, which is incorporated herein by reference in its entirety.

### GOVERNMENT SPONSORSHIP

This invention was made with Government support under Contract No. 20CWDARI00036-01-00 awarded by the Department of Homeland Security. The Government has certain rights in the invention.

### TECHNICAL FIELD

Disclosed embodiments are generally related to scintillator materials compositions as well as related methods and systems.

### BACKGROUND

Scintillator materials may be used for the detection of radiation. Radiation detection is of major interest in a host of applications including, but not limited to, nuclear medicine, fundamental physics, industrial gauging, baggage scanners, nondestructive testing, nuclear treaty verification safeguards, nuclear nonproliferation monitoring, and geological exploration. Scintillator materials with high light yields are generally desirable.

### SUMMARY

Halide-based scintillator materials, as well as related systems and methods are generally described. In some embodiments, the scintillator materials are thallium-based and/or have a perovskite structure. Specific embodiments of thallium calcium halides and thallium magnesium halides with desirable scintillation properties are provided. The subject matter of the present invention involves, in some cases, interrelated products, alternative solutions to a particular problem, and/or a plurality of different uses of one or more systems and/or articles.

In one aspect, a scintillator material is provided. The scintillator material may comprise a halide-based composition, wherein the composition has the general formula ABX₃, wherein A comprises Tl, B comprises Ca and X comprises Cl and/or Br.

In another aspect, a scintillator material is provided. The scintillator material may comprise a halide-based composition, wherein the composition has the general formula ABX₃, wherein A comprises Tl, B comprises Mg and X comprises I.

In some embodiments, a detection system is provided. The detection system may comprise: a scintillator comprising a halide-based composition and a detector assembly coupled to the scintillator and configured to detect a light pulse luminescence from the scintillator as a measure of a scintillation event.

In some embodiments, a method of radiation detection is provided. The method of radiation detection may comprise: providing a detection system including a scintillator comprising a halide-based composition and a detector assembly coupled to the scintillator and configured to detect a light pulse luminescence from the scintillator as a measure of a scintillation event; positioning the system such that a radiation source is within a field of view of the system so as to detect emissions from the source; and measuring a scintillation event luminescence signal from the scintillator with the detection assembly.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 presents a TlCl-CaCl₂ phase diagram, according to certain embodiments;

FIG. 2 presents an image of an exemplary TlCaCl₃ halide-based scintillator material, according to certain embodiments;

FIG. 3 shows an emission spectrum of an exemplary TlCaCl₃ halide-based scintillator, according to certain embodiments;

FIG. 4 shows light output and energy resolution of an exemplary TlCaCl₃ halide-based scintillator material, according to certain embodiments;

FIG. 5 shows differentiation of gamma ray detection and neutron detection using pulse shape discrimination by an exemplary TlCaCl₃ halide-based scintillator material, according to certain embodiments;

FIG. 6 shows relative light yield of an exemplary TlCaCl₃ halide-based scintillator material, according to certain embodiments;

FIG. 7 presents an image of an exemplary TlCaBr₃ halide-based scintillator, according to certain embodiments;

FIG. 8 shows an emission spectrum of an exemplary TlCaBr₃ halide-based scintillator, according to certain embodiments;

FIG. 9 shows light output and energy resolution of an exemplary TlCaBr₃ halide-based scintillator material, according to certain embodiments;

FIG. 10 shows relative light yield of an exemplary TlCaBr₃ halide-based scintillator material, according to certain embodiments; and

FIG. 11 presents an image of an exemplary TlMgI₃ halide-based scintillator material, according to certain embodiments.

### DETAILED DESCRIPTION

Scintillator materials, as well as related systems, and methods of detection using the same, are described herein. As described further below, the scintillator material composition may comprise a halide-based composition. For example, the composition may comprise a thallium halide-based composition. In particular, as described further below, the scintillator material may comprise a thallium calcium halide-based composition and/or a thallium magnesium halide-based composition. The composition is a perovskite, in some embodiments. Such materials have been shown to have particularly attractive scintillation properties and may be used in a variety of applications for detection of radiation.

In some aspects, a halide-based composition is provided. The halide-based composition may have the general formula ABX₃, wherein X is a halide. In some embodiments, the halide-based composition has the general formula ABX₃, wherein A comprises one or more of the elements K, Rb, Cs, and Tl. For example, in some embodiments, A, e.g., principally, comprises Tl.

As can be understood from the formulas above, the halide-based compositions may include thallium or one or more additional elements that substitute for thallium. For example, a group 1 element such as Cs, Li, K, Rb and/or Na may substitute for thallium on the thallium site (e.g., A site). In such embodiments, the thallium site includes at least 50% thallium; in some embodiments, at least 60% thallium; in some embodiments, at least 70% thallium; in some embodiments, at least 80% thallium; in some embodiments, at least 90% thallium; and, in some embodiments, only thallium is present on the thallium site.

In some embodiments, the halide-based composition has the general formula ABX₃, wherein B comprises one or more group 2 elements, such as Mg, Ca, Sr, and Ba. For example, in some embodiments, B, e.g., principally comprises Ca. In other embodiments, B, e.g., principally comprises Mg.

In some embodiments, the halide-based composition has the general formula ABX₃, wherein X comprises one or more group 17 elements, such as F, Cl, Br, and I. For example, in some embodiments, X, e.g., principally comprises Cl. In other embodiments, X , e.g., principally comprises Br. In still other embodiments, X, e.g., principally comprises I.

In some cases, the halide-based composition has the general formula: TlCaCl₃. As described further below, TlCaCl₃ may have attractive scintillation properties.

In some cases, the halide-based composition has the general formula: TlCaBr₃. As described further below, TlCaBr₃ may have attractive scintillation properties.

In some cases, the halide-based composition has the general formula: TlMgI₃. As described further below, TlMgI₃ may have attractive scintillation properties.

It should be understood that the scintillator compositions disclosed herein can include a dopant or a mixture of dopants. Dopants can affect certain properties, such as physical properties (e.g., brittleness, etc.) as well as scintillation properties (e.g., luminescence, etc.) of the scintillator composition. The dopant can include, for example, Ce (e.g., Ce^{3±}), Pr, Eu (e.g., Eu^{2±}), Yb, Sr, Ca, Ba, Mg, and Cd. In some cases, Ce may be preferred. In some cases, the composition is undoped.

The amount of dopant present will depend on various factors, such as the application for which the scintillator composition is being used; the desired scintillation properties (e.g., emission properties, timing resolution, etc.); and the type of detection device into which the scintillator is being incorporated. For example, the dopant may be employed at a level in the range of about 0.01% to about 20%, by molar weight. In certain embodiments, the amount of dopant is in the range of about 0.01% to less than about 20% (and any integral number therebetween), or less than about 0.1%, 1.0%, 5.0%, or 20% by molar weight.

The disclosed compositions may be prepared in any number of different forms. In some embodiments, the composition is in a crystalline form (e.g.,single crystal). In some embodiments, the composition is a perovskite. That is, the composition may have the perovskite crystal structure. In some embodiments, the composition may have other types of crystal structures. The crystal may have any suitable size and shape. Non-limiting examples of shapes include sheets, cubes, cylinders, hollow tubes, spheres, and the like.

In some cases, the composition can be in a powder form. It can also be prepared in the form of a ceramic or polycrystalline ceramic.

Methods for making the disclosed compositions can include the methods described herein or any other appropriate technique. Typically during the manufacture of many types of scintillator compositions, the appropriate reactants are melted at a temperature sufficient to form a congruent, molten composition. The melting temperature depends on the identity of the reactants themselves (e.g., melting points of reactants), but is usually in the range of about 300° C. to about 1350° C. Non-limiting examples of possible crystal-growing methods include the Bridgman-Stockbarger method; Czochralski growth method, zone-melting growth method (or “floating zone” method), the vertical gradient freeze (VGF) method, and the temperature gradient method.

Following formation of the compositions, crystals may be processed using techniques and methods known to those of ordinary skill in the art. Such processes include cutting, polishing, and/or packaging (e.g., under an inert atmosphere). In addition, the compositions may be analyzed using methods and techniques known to those of ordinary skill in the art to determine the compositional make-up of the compositions, for example, using differential scanning calorimetry (DSC) and/or crystal structure (XRD).

The compositions, methods, and systems described herein may be employed for detecting radiation. In some cases, the radiation is gamma radiation and/or neutron radiation. In some cases, the compositions, methods, and systems may be employed to differentiate neutrons from gamma rays. The timing profile of a gamma-ray scintillation event differs compared to a neutron scintillation event. For incident gamma-rays, scintillation is very fast, including a fast light decay. The neutron scintillation event exhibits a relatively slower timing profile. The difference in the timing profile between gamma-ray scintillation events and neutron scintillation events can facilitate differentiation between gamma-ray detection and neutron detection. In particular, such differences enable gamma-ray detection and neutron detection to be differentiated using pulse shape discrimination (PSD) analysis.

PSD analysis, in general, involves comparing the luminescence signal pulse shape resulting from gamma-ray detection to the luminescence signal pulse shape resulting from neutron detection. In some embodiments, it may be advantageous to use PSD analysis over relatively long time periods to differentiate gamma-ray detection and neutron detection.

The compositions described herein can be used in systems for detecting radiation. The system may comprises a detector include a scintillator material comprising a composition as described herein coupled (e.g., optically coupled) to a light detector assembly (e.g., a light photodetector, an imaging device). In use, the detector detects energetic radiation (e.g., light pulse luminescence) emitted from a source (e.g., the scintillator material). According to some embodiments, the system for detecting radiation is a fast-neutron detector system. Certain compositions described herein may have properties advantageous for fast-neutron detector systems, e.g., due to their relatively rapid scintillation decay times.

Non-limiting examples of light detector assemblies include photomultiplier tubes (PMT), photodiodes, CCD sensors, image intensifiers, silicon photomultipliers, and the like. Choice of a particular photodetector will depend in part on the type of radiation detector being fabricated and on the intended use of the device. In certain embodiments, the photodetector may be position-sensitive.

A data analysis system may be coupled to the detector. The data analysis system may include, for example, a module or system to process information (e.g., radiation detection information) from the detector/light detector assembly. The data analysis system may also include, for example, a wide variety of proprietary or commercially available computers, electronics, systems having one or more processing structures, or the like. The systems may have data processing hardware and/or software configured to implement any one (or combination of) the method steps described herein. The methods may further be embodied as programming instructions in a tangible non-transitory media such as a memory, a digital or optical recording media, or other appropriate device.

The systems themselves, which can include the detector and the light detector assembly, can be connected to a variety of tools and devices, as mentioned previously. Non-limiting examples include monitoring and detection devices (e.g., for nuclear weapons), physics research devices, well-logging tools, and imaging devices such as X-ray CT, X-ray fluoroscopy, X-ray cameras (such as for security uses), PET, homeland security (e.g., for RIIDs and/or X-ray imaging), and other nuclear medical imaging or detection devices. Various technologies for operably coupling or integrating a radiation detector assembly containing a scintillator to a detection device can be utilized with the presently disclosed materials, including various known techniques.

The systems may also be connected to a visualization interface, imaging equipment, or digital imaging equipment (e.g., pixilated flat panel devices). In some embodiments, the scintillator may serve as a component of a screen scintillator. For example, powdered scintillator material could be formed into a relatively flat plate, which is attached to a film, such as photographic film. Energetic radiation, e.g., gamma-rays and neutron, originating from a source, would interact with the scintillator and be converted into light photons, which are visualized in the developed film. The film can be replaced by amorphous silicon position-sensitive photodetectors or other position-sensitive detectors, such as avalanche diodes and the like.

In some embodiments, methods of radiation detection are provided. In some embodiments, a method of radiation detection comprises providing a detection system (e.g., as described here), positioning the detection system such that a radiation source is within a field of view of the system so as to detect emissions from the source; and measuring a scintillation event luminescence signal from the scintillator material with the detection assembly. In some embodiments, the detection system comprises a detector comprising a scintillator material as described herein (e.g., halide-based composition), and a light detection assembly coupled to the scintillator material to detect a light pulse luminescence from the scintillator as a measure of a scintillation event.

The following examples are intended to illustrate certain embodiments of the present invention, but do not exemplify the full scope of the invention.

### EXAMPLE 1

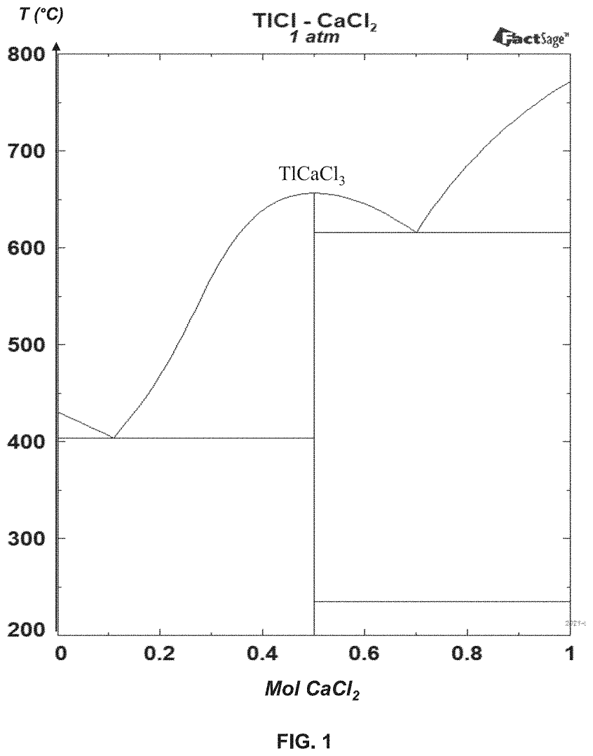

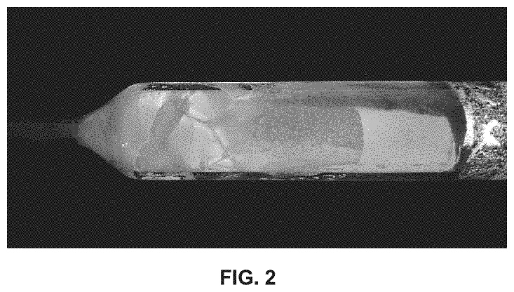

This example describes the synthesis and use of a TlCaCl₃ perovskite as a scintillation material. First, a phase diagram for a TlCl-CaCl₂ system was produced. The phase diagram is presented in FIG. 1. A narrow, single phase of TlCaCl₃ was is shown when equimolar TlCl and CaCl₂ were mixed at temperatures below approximately 650° C. Crystals of TlCaCl₃ were grown, and were observed to be translucent and colorless. FIG. 2 presents an image of an exemplary crystal of TlCaCl₃, in some embodiments.

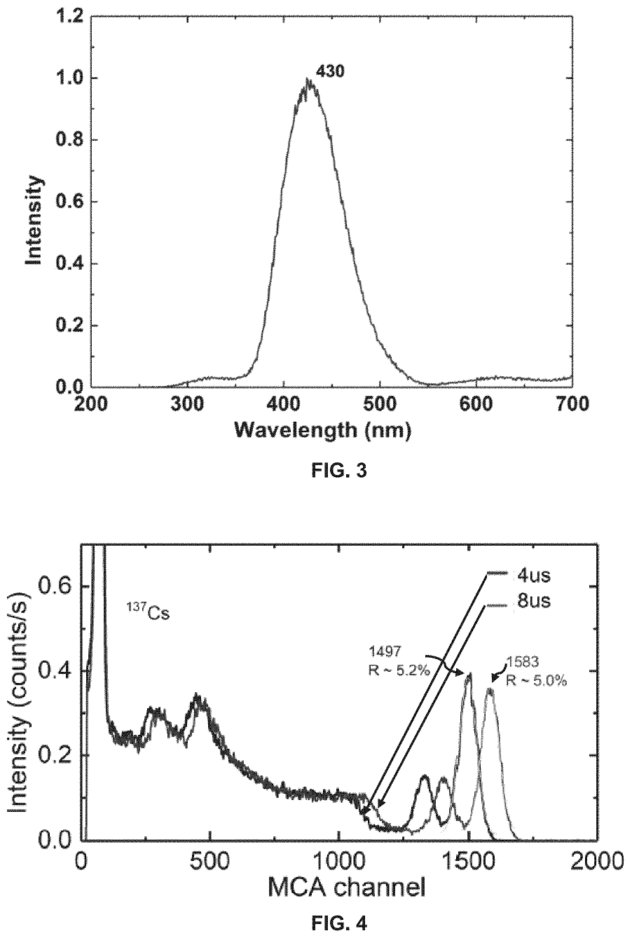

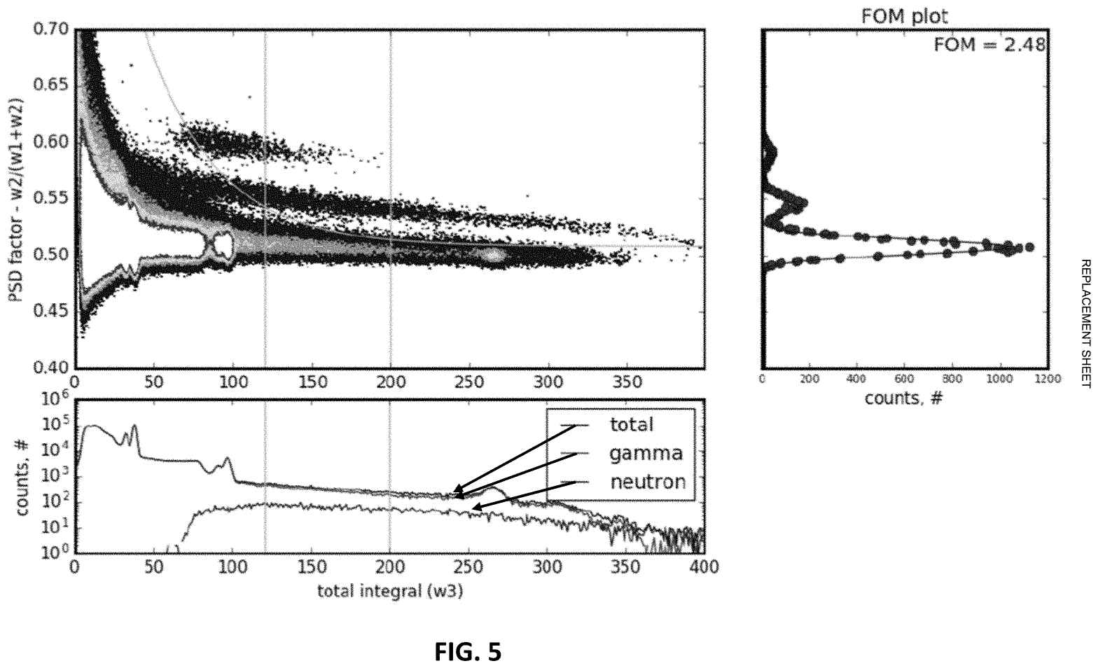

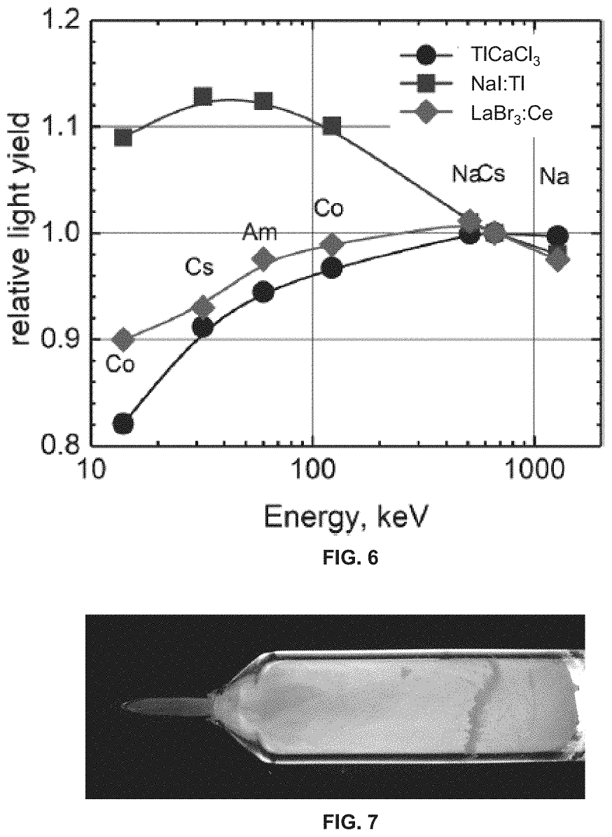

Various scintillator properties were measured using the TlCaCl₃ sample. FIG. 3 shows the emission spectrum of the TlCaCl₃ sample. FIG. 4 shows light output and energy resolution of the TlCaCl₃ sample. FIG. 5 shows differentiation of gamma ray detection and neutron detection using pulse shape discrimination (PSD) by the TlCaCl₃ sample. FIG. 6 compares the relative light yield of the TlCaC₃ sample with the relative light yield of a reference NAI:Tl system and a reference LaBr₃:Ce system as a function of energy.

The sample produced a light yield up to 26,000 ph/MeV, producing an energy revolution of 5% at 662 keV, and was observed to have a 470 ns scintillation decay (80%). These scintillation properties are desirable, in many circumstances.

### EXAMPLE 2

This example describes the synthesis and use of a TlCaBr₃ perovskite as a scintillation material. Crystals of TlCaBr₃ were prepared, and were observed to be translucent and colorless. FIG. 7 presents an image of an exemplary crystal of TlCaBr₃, in some embodiments.

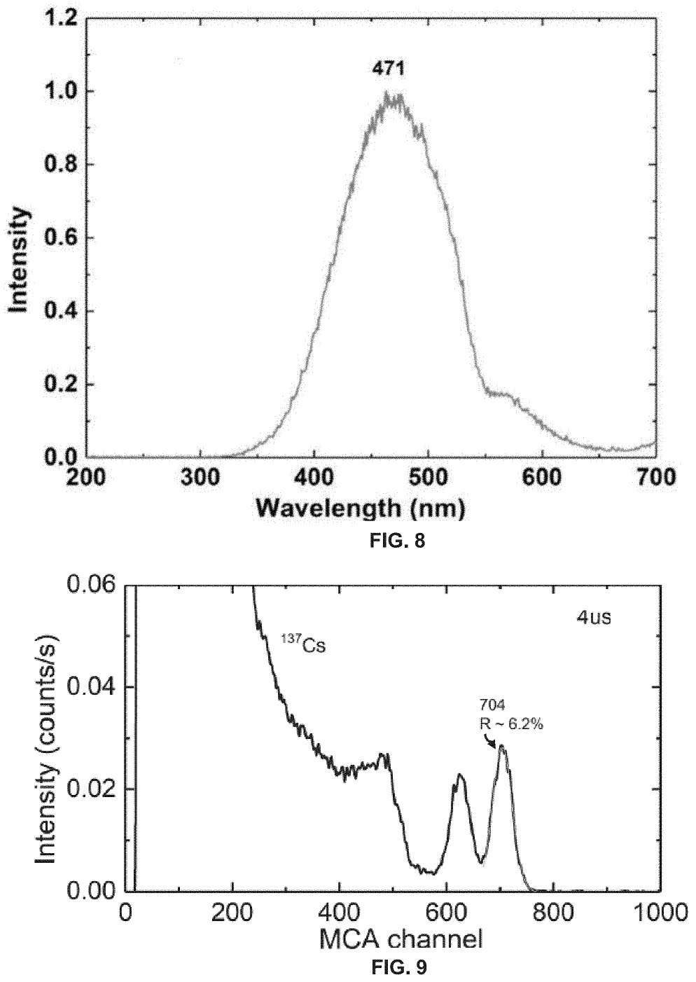

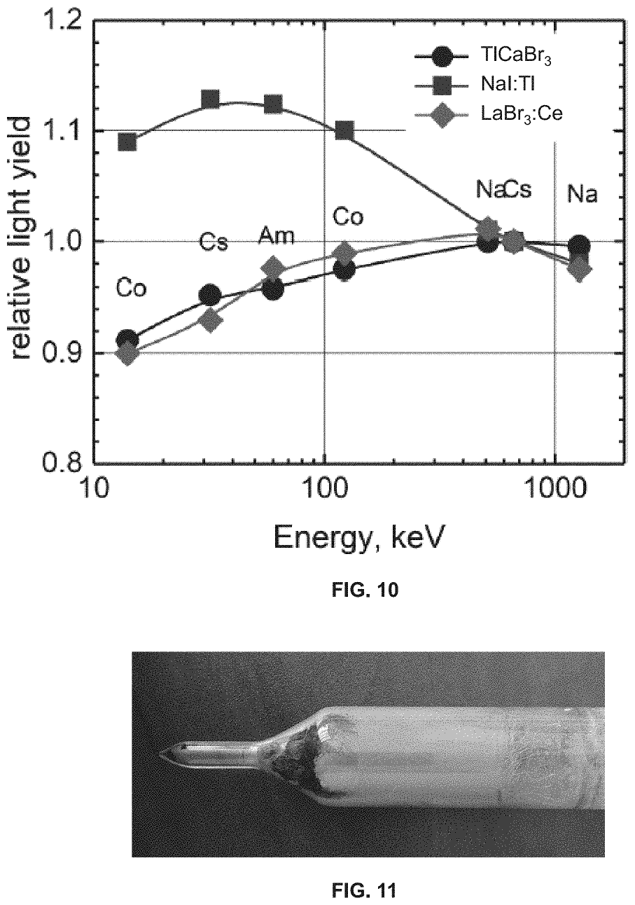

Various scintillator properties were measured using the TlCaBr₃ sample. FIG. 8 shows the emission spectrum of the TlCaBr₃ sample. FIG. 9 shows light output and energy resolution of the TlCaBr₃ sample. FIG. 10 compares the relative light yield of the TlCaBr₃ sample with the relative light yield of a reference NaI:Tl system and a reference LaBr₃:Ce system as a function of energy.

The sample produced a light yield up to 40,000 ph/MeV, producing an energy revolution of 6% at 662 keV, and was observed to have a 560 ns scintillation decay (75%). These scintillation properties are desirable, in many circumstances.

### EXAMPLE 3

This example describes the synthesis and use of a TlMgI₃ perovskite as a scintillation material. Crystals of TlMgI₃ were prepared, and were observed to be translucent and colorless. FIG. 11 presents an image of an exemplary crystal of TlMgI₃, in some embodiments.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein, “wt %” is an abbreviation of weight percentage. As used herein, “at%” is an abbreviation of atomic percentage.

1. A scintillator material comprising a halide-based composition, wherein the composition has the general formula ABX₃, wherein A comprises Tl, B comprises Ca and X comprises Cl and/or Br.

2. A scintillator material comprising a halide-based composition, wherein the composition has the general formula ABX₃, wherein A comprises Tl, B comprises Mg and X comprises I.

3. A scintillator material as in any one of claim 1, wherein the halide-based composition has a perovskite structure.

4. A scintillator material as in claim 1, wherein the halide-based composition further comprises one or more of the elements K, Rb, Cs, and Tl.

5. A scintillator material as in claim 1, wherein the halide-based composition further comprises one or more group 2 elements, such as Mg, Ca, Sr, and Ba.

6. A scintillator material as in claim 1, wherein the halide element comprises one or more group 17 elements, such as F, Cl, Br, and I.

7. A scintillator material as in claim 1, wherein the halide-based composition has the general formula: TlCaCl_{3.}

8. A scintillator material as in claim 1, wherein the halide-based composition has the general formula: TlCaBr_{3.}

9. A scintillator material as in claim 1, wherein the halide-based composition has the general formula: TlMgI_{3.}

10. A scintillator material as in claim 1, further comprising a dopant.

11. A scintillator material as in claim 1, further comprising one or more of the dopants Ce, Pr, Eu, Yb, Sr, Ca, Ba, Mg, and Cd.

12. A scintillator material as in claim 1, further comprising Ce as a dopant.

13. A detection system comprising: a scintillator comprising the halide-based composition of claim 1; and a detector assembly coupled to the scintillator and configured to detect a light pulse luminescence from the scintillator as a measure of a scintillation event.

14. A detection system as in claim 13, wherein the detection system is a fast-neutron detection system.

15. A method of radiation detection, comprising: providing a detection system including a scintillator comprising the halide-based composition of claim 1 and a detector assembly coupled to the scintillator and configured to detect a light pulse luminescence from the scintillator as a measure of a scintillation event; positioning the system such that a radiation source is within a field of view of the system so as to detect emissions from the source; and measuring a scintillation event luminescence signal from the scintillator with the detection assembly.
